(19) United States
(12) Patent Application Publication
(10) Pub. No.: US 2015/0161009 A1
(43) Pub. Date: Jun. 11, 2015

(54) BACKUP CONTROL DEVICE, BACKUP CONTROL METHOD, DISK ARRAY APPARATUS, AND STORAGE MEDIUM

(71) Applicant: NEC Corporation, Tokyo (JP)

(72) Inventor: Shinta NAKAGAWA, Tokyo (JP)

(73) Assignee: NEC Corporation

(21) Appl. No.: 14/562,989

(22) Filed: Dec. 8, 2014

(30) Foreign Application Priority Data
Dec. 11, 2013 (JP) 2013-255519

(51) Int. Cl. G06F 11/14; G06F 11/20

(52) U.S. Cl. CPC G06F 11/1451; G06F 11/2058; G06F 2201/84

(57) ABSTRACT

Disclosed is a backup control device for controlling such that backup or restore can be executed between different apparatuses even in environments not allowing backup or restore therebetween. The backup control device includes a backup control unit that, determines whether a backup to be executed is an initial backup or a differential backup on the basis of a volume management table, and generates a different copy table, determines, for each first sector number, the necessity or non-necessity of the backup on the basis of the copy table, and requests a storage apparatus to store information stored in a sector with the first sector number in a sector with a second sector number in a backup volume corresponding to the first sector number.

This application is based upon and claims the benefit of priority from Japanese Patent Application No. 2013-255519, filed on Dec. 11, 2013, the disclosure of which is incorporated herein in its entirety by reference.

### TECHNICAL FIELD

The present invention relates to a technical field of backup and restore of information stored, for example, in a storage apparatus.

### BACKGROUND ART

When any failure occurs in a disk array apparatus or a storage medium provided in the disk array apparatus, information stored in them can disappear. Accordingly, as a technique to avoid the disappearance of information, there is a system for backing up the information from a primary apparatus in operation to a secondary apparatus.

The system backs up all the information stored in a storage medium (which may be described as “full backup”), for example, when executing a first-time backup (hereinafter referred to as “initial backup” in the present application). In executing a backup after an initial backup, the system may back up information corresponding to a difference from information initially backed up (which may be hereinafter referred to as “differential backup” in the present application). Among systems achieving the differential backup, there are a system for executing backup via a management server and a system for executing backup between a plurality of disk array apparatuses.

As a technique for executing a backup for each generation (in other words, backups for a plurality of generations) of an operation volume as a backup target, there is known a snapshot technique based on a copy-on-write system.

The backup technique using snapshots does not back up information stored in the operation volume at a time in which a snapshot has been created. On the other hand, when any addition, change, and deletion (hereinafter, “addition, change, and deletion” may be described as “update” in the present application) are made in the operation volume, the backup technique backs up information of the updated portion. In other words, for example, when reading of information stored in a specific snapshot generation occurs, the backup technique refers to a snapshot where the operation volume or a portion storing the information has been lastly updated. When there occurs a difference from the past generation due to a write to the operation volume, the backup technique backs up information of a written portion at a point in time of occurrence of the difference. In this manner, the backup technique can reduce a storage region. In addition, the backup technique is generally known to have, for each snapshot generation, difference management information for managing the presence or absence of a difference, a storage location of information, and the like.

An example of related art existing prior to the present application is Patent Literature 1 (Japanese Unexamined Patent Application Publication No. 2005-267569).

Patent Literature 1 discloses techniques relating to a storage apparatus that achieves remote copy by using snapshots and an information management system.

The storage apparatus disclosed in Patent Literature 1 controls such that a past data stored in a first logical volume is written as differential data of each generation into a second logical volume. In addition, the storage apparatus manages the difference data by a snapshot management table for managing a relationship of the difference data between generations stored in the second logical volume. The storage apparatus generates a virtual logical volume of a specific generation based on the snapshot management table. Additionally, the storage apparatus creates a remote copy using the generated virtual logical volume.

For example, the backup technique described above requires various controls for each sector, as compared to full backup making a copy of the entire operation volume. More specifically, examples of such required controls include a control for determining whether copy is necessary or not according to the presence or absence of the difference and a control for address-changing and the like due to a difference between a copy source address and a copy destination address.

In addition, for example, as means for performing such controls, there is a method for controlling by a software via a communicably connected external management server which is different from the own-apparatus. However, this method requires installation of the management server and an additional cost for management software or the like for controlling the management server.

In order to avoid the problems, as the means, there is a method for controlling in cooperation, for example, by connecting two disk array apparatuses to each other. However, for example, vendors of the disk array apparatuses may be different, as a result of which specifications relating to an extension function such as backup are different, so that the method is unlikely to be able to control a backup-related operation.

Furthermore, an inexpensive disk array apparatus without an extension function such as differential backup cannot be used as a secondary apparatus. In other words, a high function apparatus needs to be introduced as the secondary apparatus. Thus, introduction of a secondary apparatus requires high cost.

Patent Literature 1 describes creation of the virtual logical volume using the snapshot management table for managing the relationship between the differential data of each generation. In addition, Patent Literature 1 describes copying using the created virtual logical volume. However, the storage apparatus disclosed in Patent Literature 1 is merely described as an apparatus that backs up the virtual logical volume. In other words, Patent Literature 1 neither considers nor describes any technique for achieving differential backup.

It is a main object of the present invention to provide a backup control device and the like controlling such that backup or restore can be executed between different apparatuses even in environments not allowing backup or restore therebetween.

### SUMMARY

In order to achieve the above object, a backup control device according to an aspect of the present invention includes the following structure.

That is, a backup control device includes:

a backup control unit that, in response to a backup request including a generation number of a snapshot, determines whether a backup to be executed is an initial backup or a differential backup on the basis of volume management information including a backup number capable of identifying the backup and a volume number capable identifying one or more volumes built in a storage apparatus as a backup destination, generates different copy information depending on a result of the determination on the basis of the generation number and difference management information managing the snapshot,

determines a necessity or non-necessity of the backup for each of one or more first sector numbers composing an operation volume on the basis of the generated copy information,

when the backup is determined to be necessary, requests, on the basis of a first sector number requiring the backup and the generation number, information stored in a sector with the first sector number from a snapshot control unit and

requests the storage apparatus to store the information acquired in response to the request in a sector with a second sector number in the volume corresponding to the first sector number.

Alternatively, the above object is also achieved by a disk array apparatus including the backup control device described above.

In addition, in order to achieve the above object, a backup control method according to another aspect of the present invention includes the following structure.

That is, the backup control method includes:

in response to a backup request including a generation number of a snapshot, determining whether a backup to be executed is an initial backup or a differential backup on the basis of volume management information including a backup number capable of identifying of the backup and a volume number capable of identifying of one or more volumes built in a storage apparatus as a backup destination;

generating different copy information depending on a result of the determination on the basis of the generation number and difference management information managing the snapshot;

determining a necessity or non-necessity of the backup for each of one or more first sector numbers composing an operation volume on the basis of the generated copy information;

when the backup is determined to be necessary, requesting, on the basis of a first sector number requiring the backup and the generation number, information stored in a sector with the first sector number from a snapshot control unit; and

requesting the storage apparatus to store the information acquired in response to the request in a sector with a second sector number in the volume corresponding to the first sector number.

The above object is also achieved by a computer program that accomplishes the backup control device and the backup control method including the above-described respective structures and a readable storage medium storing the computer program.

The present invention can provide a backup control device and the like controlling such that backup or restore can be executed between different apparatuses even in environments not allowing backup or restore therebetween.

### BRIEF DESCRIPTION OF THE DRAWINGS

Exemplary features and advantages of the present invention will become apparent from the following detailed description when taken with the accompanying drawings in which:

FIG. 1 is a block diagram depicting a structure of a backup control device according to a first exemplary embodiment of the present invention;

FIG. 2 is a diagram specifically exemplifying a copy table in the first exemplary embodiment of the invention;

FIG. 3 is a diagram specifically exemplifying a difference management table in the first exemplary embodiment of the invention;

FIG. 4 is a diagram specifically exemplifying a volume management table in the first exemplary embodiment of the invention;

FIG. 5 is a flowchart depicting table generation processing executed by a backup control unit in the first exemplary embodiment of the invention;

FIG. 6A is a flowchart depicting an operation executed by the backup control unit when receiving a backup request in the first exemplary embodiment of the invention;

FIG. 6B is the flowchart depicting the operation executed by the backup control unit when receiving a backup request in the first exemplary embodiment of the invention;

FIG. 7 is a block diagram depicting a structure of a first disk array apparatus including a backup control device according to a second exemplary embodiment of the invention;

FIG. 8A is a flowchart depicting an operation executed by a restore control unit when receiving a restore request in the second exemplary embodiment of the invention;

FIG. 8B is the flowchart depicting the operation executed by the restore control unit when receiving a restore request in the second exemplary embodiment of the invention;

FIG. 9 is a block diagram depicting a structure of a first disk array apparatus including a backup control device according to a third exemplary embodiment of the invention; and

FIG. 10 is a block diagram exemplarily illustrating a hardware structure of an information processor capable of achieving each of the exemplary embodiments of the invention.

### EXEMPLARY EMBODIMENT

Hereinbelow, a detailed description will be given of exemplary embodiments of the present invention with reference to the drawings.

### First Exemplary Embodiment

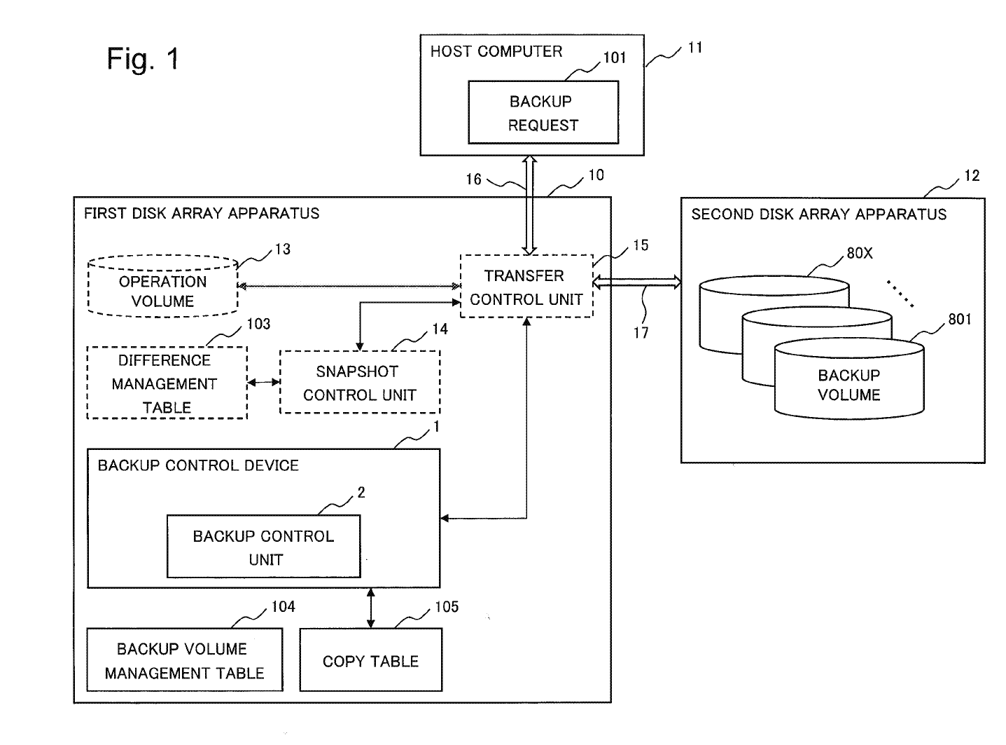

FIG. 1 is a block diagram depicting a structure of a first disk array apparatus 10 including a backup control device 1 according to a first exemplary embodiment of the present invention.

In FIG. 1, the backup control device 1 includes a backup control unit 2.

The disk array apparatus 10 is connected with a host computer 11 via an interface 16. The first disk array apparatus 10 is also connected to a second disk array apparatus 12 via an interface 17.

The first disk array apparatus 10 includes an operation volume 13, a snapshot control unit 14, a transfer control unit 15, a difference management table 103, a backup volume management table 104, and a copy table 105.

For descriptive convenience, in the description below, the difference management table will be referred to also as “difference management information”. In addition, the backup volume management table will be referred to also as “backup volume management information” in the description below. Alternatively, the “backup volume management table” will be referred to simply as “volume management table” in the description below. Furthermore, in the description below, the copy table will be referred to also as “copy information”. Hereinafter, the same is applied to each embodiment.

More specifically, the backup control unit 2 starts processing in response to reception of a backup request 101, for example, from an external apparatus such as the host computer 11 via the transfer control 15.

The backup request 101 herein includes a generation number indicating a generation of a snapshot as a backup target. More specifically, the backup request 101 is, for example, a command for instructing acquisition of a backup including the generation number (an acquisition command).

For descriptive convenience in the description below, as one example, “a generation number that indicates a snapshot generation included in the backup request 101” will be referred to as “first generation number” (hereinafter the same shall apply to each embodiment).

On the basis of the volume management table 104, the backup control unit 2 determines whether a backup to be executed is a first-time backup or a backup of a difference in an update made after the first-time backup.

For descriptive convenience in the description below, as one example, “first-time backup” will be referred to as “initial backup”, and “backup of a difference in an update made after the first-time backup” will be referred to as “differential backup”. Additionally, in the description below, “a sector number that designates one or more sectors composing the operation volume 13” will be referred to as “first sector number”. Hereinafter, the same is applied to each embodiment.

As a result of determining whether the backup is an initial backup or a differential backup, when the backup control unit 2 determines that it is the initial backup, the backup control unit 2 executes the following processing. Specifically, the backup control unit 2 generates the copy table 105 so that all sectors of the one or more sectors composing the operation volume 13 become a backup target.

On the other hand, when the backup control unit 2 determines if the backup is the differential backup as a result of determining whether it is the initial backup or the differential backup, the backup control unit 2 executes the following processing. Specifically, the backup control unit 2 generates the copy table 105 on the basis of the difference management table 103 and the first generation number included in the backup request 101. More specifically, the backup control unit 2 generates the copy table 105 so that the one or more sectors composing the operation volume 13, one or more sectors in which a difference has occurred after the initial backup become a backup target.

The copy table 105 will be described more specifically below.

The copy table 105 includes a first sector number that designates the one or more sectors composing the operation volume 13 and information that indicates whether or not a difference has occurred in information (a byte data sequence) stored in a sector designated by the first sector number after the initial backup. In other words, the copy table 105 is information in which the first sector number are associated with first difference information as information indicating the occurrence or non-occurrence of a difference (in other words, the presence or absence of a difference).

For descriptive convenience in the description below, as one example, “sector designated by the first sector number” may be simply described as “sector with the first sector number”. In addition, in the description below, “information indicating the presence or absence of a difference that has occurred after the initial backup” will be referred to as “first difference information” (hereinafter, the same is applied to each embodiment).

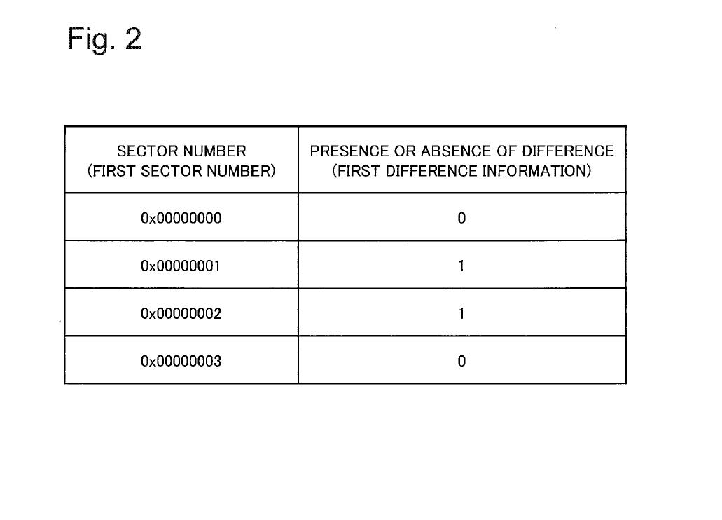

FIG. 2 is a diagram specifically exemplifying the copy table 105 in the first exemplary embodiment of the invention.

A first column of the copy table 105 shown in FIG. 2 indicates first sector numbers, and in a second column indicates the first difference information.

Table generation processing for generating the copy table 105 by the backup control unit 2 will be described in detail later in the present exemplary embodiment.

Next, the difference management table 103 will be described below more specifically.

The difference management table 103 is a management table for managing snapshots of the operation volume 13 by the snapshot control unit 14.

Accordingly, the difference management table 103 includes, for each snapshot generation, information in which the first sector number designating the one or more sectors composing the operation volume 13 are associated with information indicating the presence or absence of a difference. The information indicating the presence or absence of a difference herein is information indicating whether or not a difference has occurred (in other words, the presence or absence of a difference) in information stored in the sector designated by the first sector number after acquisition of a snapshot.

For descriptive convenience in the description below, as one example, “generation of snapshot” may be described simply as “generation”. Additionally, in the description below, information indicating the presence or absence of a difference having occurred in the above-described information may be referred to also as “second difference information”. Hereinafter, the same is applied to each embodiment.

More specifically, the difference management table 103 will be described below in more detail. The following is a description regarding when the operation volume 13 is updated during a period of time from acquisition of a snapshot to an acquisition of a next snapshot by the snapshot control unit 14. The difference management table 103 is a management table in which the first sector number designating updated sector and the information indicating that a difference has occurred after acquisition of a snapshot (the second difference information) are associated with each other and recorded. In other words, the difference management table 103 includes, for each snapshot generation, the first sector number and information indicating whether or not any update has been made in the sector with the first sector number.

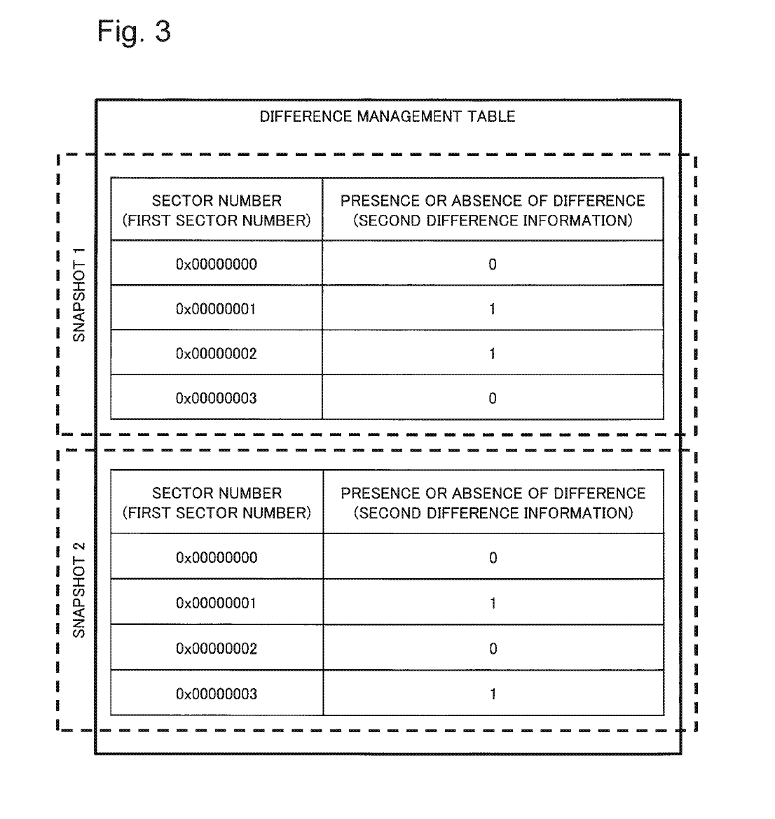

FIG. 3 is a diagram specifically exemplifying the difference management table 103 in the first exemplary embodiment of the invention.

In FIG. 3, the difference management table 103 includes a difference management table for each snapshot generation, as indicated by dotted lines. In addition, first columns indicate the first sector number designating one or more sectors composing the operation volume 13 (exemplified as data of 8 bytes (0x)). Then, second columns indicate second difference information by 1-bit values.

As one example, the snapshot control unit 14 stores “1” that indicates the occurrence of a difference in the second difference information when a difference occurs. In other words, the snapshot control unit 14 includes the information indicating the occurrence of a difference in the second difference information. On the other hand, when no difference occurs, the snapshot control unit 14 stores “0” that indicates no occurrence of a difference in the second difference information.

Next, the following will describe the volume management table 104 more specifically.

The volume management table 104 includes a backup numbers that allow identification of backups executed by the backup control unit 2 and a backup volume number that allow identification of backup volumes storing information backed up thereby. In other words, the volume management table 104 is information in which the backup numbers are associated with the backup volume numbers of backup destinations.

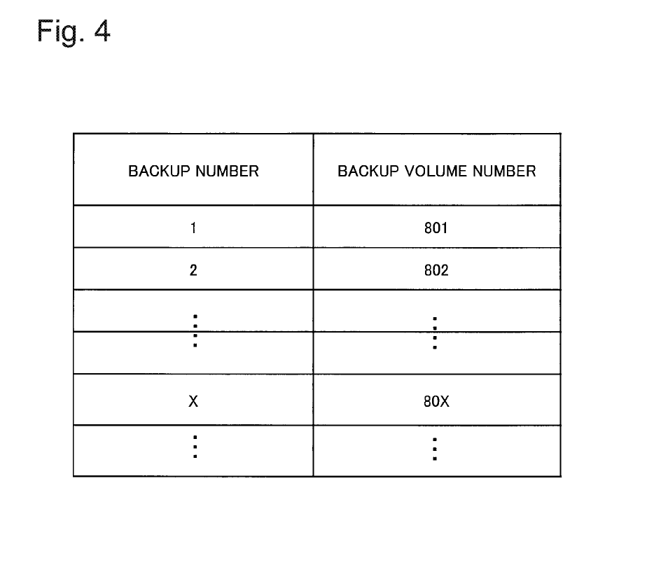

FIG. 4 is a diagram specifically exemplifying the volume management table 104 in the first exemplary embodiment of the invention.

A first column of the volume management table 104 shown in FIG. 4 indicates the backup numbers, and a second column of the volume management table 104 shown in FIG. 4 indicates backup volume numbers.

As one example, it is assumed that, of the backup numbers, the backup number indicating an initial backup is “1”. In addition, the backup number indicating a backup to be executed after the initial backup (that is, a differential backup) is assumed to be “2”. In other words, the backup control unit 2 generates a backup number by adding “1” to a backup number of a previously executed backup each time a backup is executed.

Additionally, as one example, the backup volume number may be created by adding backup number to ends of the backup volume number. More specifically, for example, when the backup number is “1”, the backup volume number is assumed to be “801”. In addition, when backup number is “2”, the backup volume number is assumed to be “802”.

In this way, the backup control unit 2 may adopt the structure in which the backup volume numbers are assumed to be those that allow identification of a plurality of backup volumes, such as “801”, “802”, “803”, . . . and “80X”. Alternatively, the backup control unit 2 refers to the volume management table 104. Then, as a result of the reference, the backup control unit 2 may adopt a structure in which the backup volume numbers are assumed to be those different from backup volume numbers already registered in the volume management table 104 (in other words, those unregistered therein). However, the present invention described by exemplification of the present exemplary embodiment is not limited to the above structures (hereinafter, the same is applied to each embodiment).

Next, the backup control unit 2 calculates a capacity of a backup volume necessary for backup on the basis of the generated copy table 105. The backup control unit 2 requests, for example, a storage apparatus such as the second disk array apparatus 12 to build a backup volume on the basis of the backup volume number and the calculated backup volume capacity. The backup control unit 2 associates a volume number of the backup volume built in response to the build request with a backup number and stores the volume in the volume management table 104. In other words, the backup control unit 2 associates the volume numbers with backup numbers to include those numbers in the volume management table 104.

The backup control unit 2 also determines, for each the first sector number, whether backup is necessary or not on the basis of the copy table 105. When the backup control unit 2 determines that backup is necessary as a result of the determination, the backup control unit 2 executes the following processing. Specifically, the backup control unit 2 controls such that information stored in a sector with a first sector number is backed up in a sector with a second sector number in a backup volume corresponding to the first sector number.

The backup volume corresponding to the first sector number herein is the backup volume built in response to the build request. In addition, the second sector number is a sector number that designates the sector of the backup volume as a backup destination of the information stored in the sector with the first sector number. In other words, the second sector number is a sector number corresponding to each of the one or more first sector numbers.

More specifically, the backup control unit 2 refers to the copy table 105 on the basis of each first sector number. From the referred copy table 105, the backup control unit 2 obtains information indicating the presence or absence of a difference having occurred after the initial backup (first difference information), corresponding to the first sector number.

The backup control unit 2 determines whether the information stored in the sector with the first sector number needs to be backed up or not on the basis of the obtained first difference information. When the backup control unit 2 determines that the backup is necessary as a result of the determination of the necessity or non-necessity of the backup, the backup control unit 2 executes the following processing. On the basis of the first sector number and a first generation number included in the backup request 101, the backup control unit 2 requests information stored in the sector with the first sector number in a snapshot designated by the first generation number from the snapshot control unit 14. In that case, the backup control unit 2 makes the request to the snapshot control unit 14 via the transfer control unit 15.

The backup control unit 2 requests the second disk array apparatus 12 to store the information obtained in response to the request in the sector with the second sector number in the built backup volume via the transfer control unit 15. The backup control unit 2 executes the above-described processing for all of the first sector numbers composing the operation volume 13.

Thereby, in response to the request from the backup control unit 2, the second disk array apparatus 12 stores the obtained information in the sector with the second sector number in the designated backup volume.

The snapshot control unit 14 manages, for each generation, a snapshot (a virtual duplicate) of the operation volume 13 as a backup target. In addition, the snapshot control unit 14 controls access to the snapshot.

More specifically, when receiving a snapshot-acquisition-command, the snapshot control unit 14 acquires a snapshot of the operation volume 13 at the point in time of reception of the command. The snapshot control unit 14 transmits a result of the execution to a transmission source of the command.

When receiving a snapshot-read-command, the snapshot control unit 14 transmits information stored in a sector with the first sector number in a snapshot designated by the command to a transmission source of the command. The snapshot-read-command herein includes a generation number indicating a generation of the snapshot and the first sector number.

The snapshot control unit 14 executes the following processing when the operation volume 13 is updated during a period of time from acquisition of the snapshot to acquisition of a next snapshot. In other words, the snapshot control unit 14 associates the first sector number designating an updated sector with information indicating the occurrence of a difference (second difference information) in the acquired snapshot to store them in the difference management table 103. In addition, when recording the first sector number and the second difference information in the difference management table 103, the snapshot control unit 14 backs up pre-update information stored in the sector with the first sector number.

The host computer 11 transmits various commands to the backup control device 1, the operation volume 13, and the snapshot control unit 14 via the transfer control unit 15.

More specifically, the host computer 11 transmits a write command or a read command to the operation volume 13. In addition, the host computer 11 transmits the snapshot-acquisition-command or the snapshot-read-command to the snapshot control unit 14. Then, the host computer 11 transmits a backup-acquisition-command (the backup request 101) or a backup-restore-command (a restore request 102 described later in a second exemplary embodiment of the invention) to the backup control device 1.

The second disk array apparatus 12 includes one or more backup volumes 801 to 80X built in response to the build request for a backup volume. Additionally, in response to reception of various commands from outside, the second disk array apparatus 12 executes processing in response to each of the commands. Examples of the various commands include a backup-volume-build-command, a write command for writing to the backup volumes 801 to 80X, and a read command for reading the backup volumes 801 to 80X.

More specifically, for example, the second disk array apparatus 12 builds the backup volume in response to the build request for a backup volume. Then, the second disk array apparatus 12 transmits a result of the execution to a request source. In other words, the second disk array apparatus 12 builds a backup volume having a volume number designated by the build request on the basis of a designated volume capacity.

Additionally, for example, in response to the write command or the read command, the second disk array apparatus 12 transmits the command to the backup volumes 801 to 80X. The second disk array apparatus 12 waits for completion of the command. Then, when receiving the write command, the second disk array apparatus 12 transmits a result of the execution to a transmission source of the command. When receiving the read command, the second disk array apparatus 12 transmits a result of the execution and read information to a transmission source of the command.

The operation volume 13 and the backup volumes 801 to 80X are storage devices storing a byte data sequence in each sector unit having a fixed length. In addition, the operation volume 13 and the backup volumes 801 to 80X execute processing in response to commands such as the write command and the read command.

Hereinafter, a more specific description will be given of an example of processing executed by the operation volume 13 when receiving each of the various commands. When receiving the write command, the operation volume 13 stores a byte data sequence in a sector with a sector number included in the write command. Next, the operation volume 13 transmits a result of the execution to a transmission source of the command. Additionally, when receiving the read command, the operation volume 13 transmits a byte data sequence stored in a sector with a sector number included in the read command to a transmission source of the command.

Examples of the various commands transmitted and received by the first disk array apparatus 10, the host computer 11, and the second disk array apparatus 12 include SCSI (Small_Computer_System_Interface) commands, but are not limited thereto as long as required information can be transmitted.

Structures of the operation volume 13 and the backup volumes 801 to 80X can be any as long as they allow read and write instructions for each sector or each data storage unit having a fixed length equivalent thereto.

Next, a more specific description will be given below of table generation processing executed by the backup control unit 2 in the present exemplary embodiment.

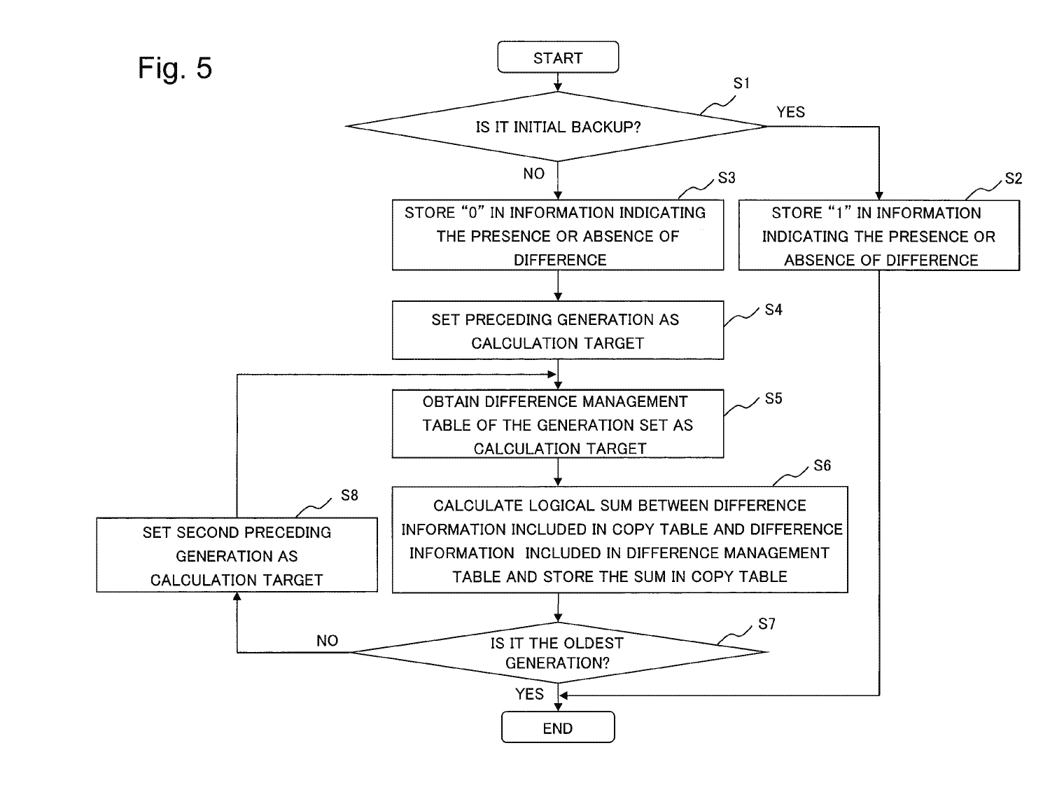

FIG. 5 is a flowchart depicting the table generation processing executed by the backup control unit 2 in the first exemplary embodiment of the invention. Steps of operation of the backup control unit 2 will be described in accordance with the flowchart.

### Step S1:

The backup control unit 2 determines whether or not an backup to be executed is the initial backup on the basis of the volume management table 104. Specifically, the backup control unit 2 determines whether the backup is the initial backup or the differential backup on the basis of the volume management table 104.

More specifically, the backup control unit 2 refers to the volume management table 104. Then, the backup control unit 2 determines whether or not the backup is the initial backup by determining whether or not any entry has been registered in the volume management table 104.

### “YES” at Step S1:

The backup control unit 2 advances processing to step S2 when the backup control unit 2 determines that the backup is the initial backup as a result of determining whether or not it is the initial backup.

More specifically, the backup control unit 2 determines that the backup is the initial backup when there is no entry registered in the volume management table 104.

### “NO” at Step S1:

The backup control unit 2 advances processing to step S3 when the backup control unit 2 determines that the backup is not the initial backup as a result of determining whether or not it is the initial backup. In other words, the backup control unit 2 advances processing to step S3 when it determines that the backup is the differential backup.

More specifically, the backup control unit 2 determines that it is not the initial backup (in other words, it is a differential backup) when there is an entry registered in the volume management table 104.

### Step S2:

For each of all the first sector numbers included in the copy table 105, the backup control unit 2 stores information indicating that there is a difference in first difference information corresponding to the first sector number. Furthermore, the backup control unit 2 associates the first sector number with the first difference information corresponding to the first sector number to store them in the copy table 105. In other words, the backup control unit 2 associates the first sector number with the first difference information to include them in the copy table 105.

More specifically, as one example, the backup control unit 2 stores, for each of all the first sector numbers, “1” indicating that there is a difference in a bit indicating the first difference information corresponding to the first sector number. Furthermore, the backup control unit 2 associates the first sector number with the bit indicating the first difference information corresponding to the first sector number to store them in the copy table 105.

### Step S3:

The backup control unit 2 stores, for each of all the first sector numbers included in the copy table 105, information indicating that there is no difference, in the first difference information corresponding to the first sector number. Furthermore, the backup control unit 2 associates the first sector number with the first difference information corresponding to the first sector number to store them in the copy table 105.

More specifically, as one example, the backup control unit 2 stores, for each of all the first sector numbers, “0” indicating that there is no difference in a bit indicating the first difference information corresponding to the first sector number. Furthermore, the backup control unit 2 associates the first sector number with the bit indicating the first difference information corresponding to the first sector number to store them in the copy table 105.

### Step S4:

The backup control unit 2 sets a generation immediately before a generation with a first generation number included in the backup request 101 to a target for calculation by a logical sum.

### Step S5:

The backup control unit 2 refers to the difference management table 103. The backup control unit 2 obtains a difference management table of the generation set as the target of calculation of a logical sum from the difference management table 103.

### Step S6:

The backup control unit 2 calculates, for each of all the first sector numbers, a logical sum between first difference information included in the copy table 105 and second difference information included in the obtained difference management table. The backup control unit 2 associates the logical sum with the each first sector number to store them in the copy table 105. In other words, the backup control unit 2 associates the logical sum with the each first sector number to include them in the copy table 105.

More specifically, as one example, the following will describe a calculation of a logical sum between second difference information corresponding to a specific first sector number (“0x00000001”) and first difference information.

Herein, first difference information corresponding to a specific first sector number included in the copy table 105 is assumed to be “1”. In addition, in the description below, second difference information corresponding to the specific first sector number included in the obtained difference management table is assumed to be “0”.

The backup control unit 2 calculates a logical sum between the bit “1” indicating the first difference information and the bit “0” indicating the second difference information. The backup control unit 2 associates the logical sum “1” with the specific first sector number to store them in the copy table 105.

### Step S7:

The backup control unit 2 determines whether or not the generation set as the target of calculation of the logical sum is the oldest of the generations included in the difference management table 103.

More specifically, as one example, the following will describe a case in which generation numbers of snapshots are managed in order from the oldest to the newest, as “1, 2, 3, . . . , and n”. In that case, the backup control unit 2 may adopt a structure of determining that when a generation set as the target of calculation of a logical sum is “1”, the set generation is the oldest one. However, the present invention described by exemplifying the present exemplary embodiment is not limited to the above structure (hereinafter, the same is applied to each embodiment).

### “YES” at Step S7:

The backup control unit 2 ends the table generation processing when the backup control unit 2 determines that the generation is the oldest as a result of determining whether or not the generation is the oldest.

### “NO” at Step S7:

The backup control unit 2 advances processing to step S8 when the backup control unit 2 determines that the generation is not the oldest as a result of determining whether or not it is the oldest generation.

### Step S8:

The backup control unit 2 further sets a generation immediately before the generation set as the target of calculation of the logical sum, as a target of calculation of a logical sum. The backup control unit 2 returns processing to step S5.

In this way, the backup control unit 2 calculates logical sum for all snapshot generations acquired before the first generation number included in the backup request 101. Then, the backup control unit 2 associates the logical sum with the first sector numbers to store in the copy table 105.

Next, a more specific description will be given below of an operation executed by the backup control unit 2 in the present exemplary embodiment.

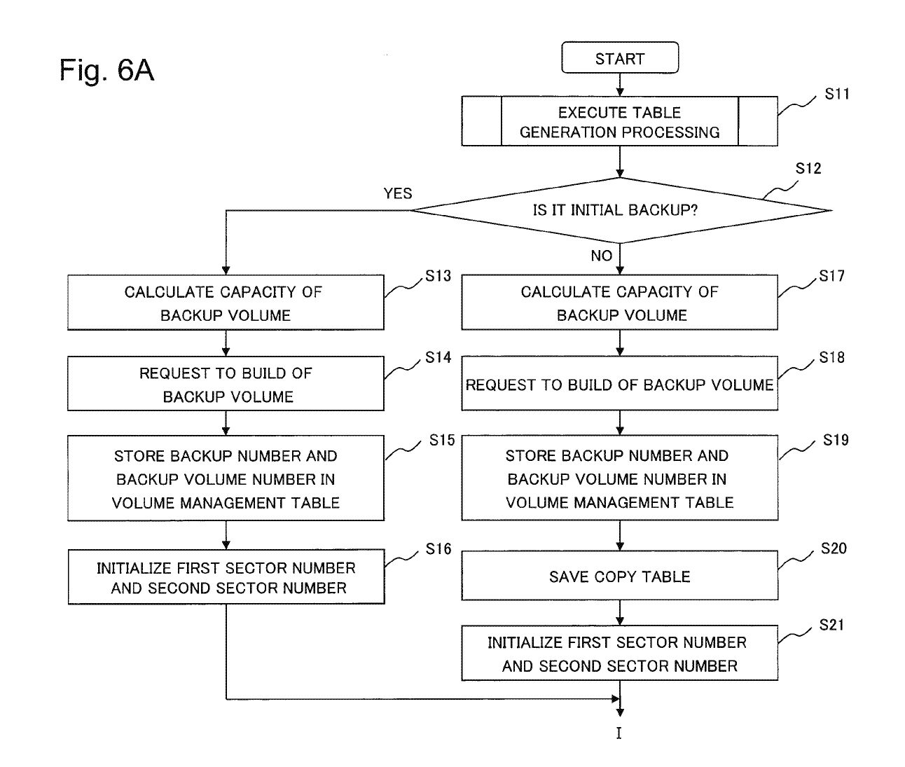

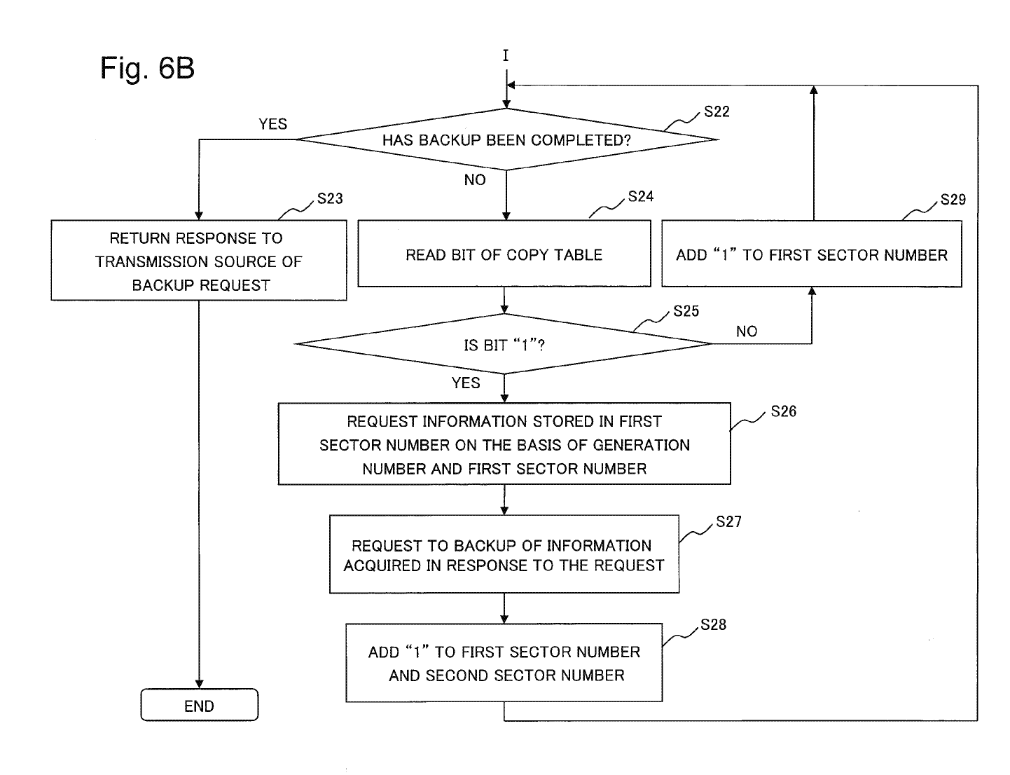

FIGS. 6A and 6B are a flowchart depicting an operation executed by the backup control unit 2 when receiving the backup request 101 in the first exemplary embodiment of the invention. Steps of the operation by the backup control unit 2 will be described in accordance with the flowchart.

### Step S11:

The backup control unit 2 executes the table generation processing described in FIG. 5 in response to reception of the backup request 101 including a first generation number. Thus, a duplicated description will be omitted.

### Step S12:

The backup control unit 2 determines whether or not backup is the initial backup on the basis of the volume management table 104. The processing for determining whether or not it is the initial backup is the same as the processing described at step S1 (FIG. 5), and thus a duplicated description will be omitted.

### “YES” at Step S12:

The backup control unit 2 advances processing to step S13 when the backup control unit 2 determines that the backup is the initial backup as a result of determining whether or not it is the initial backup.

### “NO” at Step S12:

The backup control unit 2 advances processing to step S17 when the backup control unit 2 determines that the backup is not the initial backup as a result of determining whether or not it is the initial backup. In other words, the backup control unit 2 advances processing to step S17 when it determines that the backup is a differential backup.

### Step S13:

The backup control 2 calculates a capacity of a backup volume necessary for backup on the basis of the copy table 105 generated by the table generation processing.

More specifically, the backup control unit 2 refers to the copy table 105. The backup control unit 2 calculates a total number of effective bits from the copy table 105.

### Step S14:

The backup control unit 2 requests the second disk array apparatus 12 to build a backup volume on the basis of the obtained capacity of the backup volume and a backup volume number.

More specifically, the backup control unit 2 transmits a volume-build-command including the backup volume number and the backup volume capacity to the second disk array apparatus 12 via the transfer control unit 15.

Thereby, the second disk array apparatus 12 receives the volume-build-command. Then, the second disk array apparatus 12 builds a backup volume having the backup volume number on the basis of the command. Additionally, the second disk array apparatus 12 transmits a result of the execution to the backup control unit 2 via the transfer control unit 15.

### Step S15:

The backup control unit 2 stores an entry including a backup number and the volume number of the backup volume built in response to the build request in the volume management table 104. In other words, the backup control unit 2 associates the backup number with the backup volume number to store them in the volume management table 104.

### Step S16:

The backup control unit 2 initializes the first sector number as a duplication source and the second sector number as a duplication destination corresponding to the first sector number. Additionally, the backup control unit 2 advances processing to step S22.

More specifically, the backup control unit 2 stores “0x00000001” as an initial value in the first sector number, and “0x00000001” in the second sector number. In other words, in the case of initial backup, the backup control unit 2 initializes such that the first sector number “0x00000001” is the same as the second sector number “0x00000001”.

### Step S17:

The backup control unit 2 calculates a capacity of a backup volume necessary for backup on the basis of the copy table 105 generated by the table generation processing.

More specifically, the backup control unit 2 refers to the copy table 105. The backup control unit 2 calculates a total number of effective bits from the copy table 105. In addition, the backup control unit 2 adds “1” to the obtained total number of the effective bits. In other words, calculation processing for the volume capacity in differential backup is different from calculation processing for the volume capacity in the initial backup indicated at step S13 in terms of adding “1” to the obtained total number of the effective bits.

### Step S18:

The backup control unit 2 requests the second disk array apparatus 12 to build the backup volume on the basis of the obtained backup volume capacity and the backup volume number.

### Step S19:

The backup control unit 2 stores an entry including the backup number and the volume number of the backup volume built in response to the build request in the volume management table 104.

### Step S20:

The backup control unit 2 requests the second disk array apparatus 12 to save the copy table 105 in the backup volume built in response to the build request.

More specifically, the backup control unit 2 transmits the write command to the second disk array apparatus 12 via the transfer control unit 15. The write command herein includes the volume number of the backup volume built in response to the build request, a predetermined sector number “0x00000001” of the backup volume, and a byte data sequence indicating the copy table 105.

Thereby, the second disk array apparatus 12 receives the write command from the backup control unit 2 via the transfer control unit 15. Then, on the basis of the write command, the second disk array apparatus 12 saves the copy table 105 in a sector designated by the predetermined sector number “0x00000001” of the backup volume. Additionally, the second disk array apparatus 12 transmits a result of the execution to the backup control unit 2 via the transfer control unit 15.

### Step S21:

The backup control unit 2 initializes the first sector number as a duplication source and a second sector number as a duplication destination corresponding to the first sector number.

More specifically, the backup control unit 2 stores “0x00000001” as an initial value in the first sector number and then stores “0x00000002” in the second sector number. In other words, the initialization processing in differential backup is different from the initialization processing in initial backup depicted at step S16 in terms of storing “0x00000002” in the second sector number.

### Step S22:

The backup control unit 2 determines whether the backup has been completed or not on the basis of a total number of the sectors in the operation volume 13 and the first sector number.

More specifically, as one example, the backup control unit 2 calculates the total number of the sectors in the operation volume 13. Next, the backup control unit 2 determines whether or not the first sector number has exceeded the obtained total number of the sectors.

### “YES” at Step S22:

The backup control unit 2 advances processing to step S23 when the backup control unit 2 determines that the backup has been completed as a result of determining whether or not the backup has been completed.

More specifically, as one example, as a result of determining whether or not the first sector number has exceeded the total number of the sectors, when the backup control unit 2 determines that the first sector number has exceeded the total number of the sectors, the backup control unit 2 advances processing to step S23.

### “NO” at Step S22:

The backup control unit 2 advances processing to step S24 when the backup control unit 2 determines that the backup has not been completed as a result of determining whether or not the backup has been completed.

More specifically, as one example, as a result of determining whether or not the first sector number has exceeded the total number of the sectors, when the backup control unit 2 determines that the first sector number has exceeded the total number of the sectors, the backup control unit 2 advances processing to step S24.

### Step S23:

The backup control unit 2 transmits a result of the execution to the transmission source of the backup request 101. In other words, the backup control unit 2 returns a response to the host computer 11 as the transmission source of the backup request 101.

### Step S24:

The backup control unit 2 refers to the copy table 105 generated by the table generation processing on the basis of the first sector number. The backup control unit 2 obtains first difference information corresponding to the first sector number from the copy table 105.

More specifically, the backup control unit 2 reads a bit indicating the first difference information corresponding to the first sector number from the copy table 105.

### Step S25:

The backup control unit 2 determines whether backup for the information stored in the sector with the first sector number is necessary or not on the basis of the obtained first difference information.

### “YES” at Step S25:

The backup control unit 2 advances processing to step S26 when the backup control unit 2 determines that the backup is necessary as a result of determining whether the backup is necessary or not.

More specifically, as a result of determining whether the backup is necessary or not on the basis of the bit indicating the obtained first difference information, when the bit is “1”, the backup control unit 2 determines that it is necessary to back up the information stored in the sector with the first sector number.

### “NO” at Step S25:

The backup control unit 2 advances processing to step S29 when the backup control unit 2 determines that the backup is not necessary (that is, unnecessary) as a result of determining whether the backup is necessary or not.

More specifically, as a result of determining whether the backup is necessary or not on the basis of the bit indicating the obtained first difference information, when the bit is “0”, the backup control unit 2 determines that it is unnecessary to back up the information stored in the sector with the first sector number.

### Step S26:

The backup control unit 2 requests the information stored in the sector with the first sector number in the snapshot having the first generation number from the snapshot control unit 14 on the basis of the first generation number and the first sector number included in the backup request 101. In that case, the backup control unit 2 makes the request to the snapshot control unit 14 via the transfer control unit 15.

More specifically, the backup control unit 2 transmits the snapshot-read-command including the first generation number and the first sector number included in the backup request 101 to the snapshot control unit 14 via the transfer control unit 15.

### Step S27:

The backup control unit 2 requests the second disk array apparatus 12 to store the information obtained in response to the request on the basis of the volume number of the backup volume built in response to the build request and the second sector number corresponding to the first sector number. In that case, the backup control unit 2 request for the second disk array apparatus 12, via the transfer control unit 15, to storage the obtained information.

More specifically, the backup control unit 2 transmits the write command to the second disk array apparatus 12 via the transfer control unit 15. The write command herein includes a byte data sequence obtained in response to the request, the backup volume number, and the second sector number.

Thereby, the second disk array apparatus 12 receives the write command from the backup control unit 2 via the transfer control unit 15. Then, on the basis of the write command, the second disk array apparatus 12 stores the byte data sequence in the sector with the second sector number of the backup volume. Additionally, the second disk array apparatus 12 transmits a result of the execution to the backup control unit 2 via the transfer control unit 15.

### Step S28:

The backup control unit 2 adds “1” to the first sector number and the second sector number corresponding to the first sector number. In addition, the backup control unit 2 returns processing to step S22.

More specifically, in the description below, for example, at step S16, “0x00000001” is assumed to be stored in the first sector number, as well as “0x00000001” is assumed to be stored in the second sector number. In that case, the backup control unit 2 adds “1” to the first sector number and the second sector number, whereby the first sector number becomes “0x00000002” and the second sector number also becomes “0x00000002”.

As another specific example, in the description below, for example, at step S21, “0x00000001” is assumed to be stored in the first sector number, as well as “0x00000002” is assumed to be stored in the second sector number. In that case, the backup control unit 2 adds “1” to the first sector number and the second sector number, whereby the first sector number becomes “0x00000002” and the second sector number becomes “0x00000003”.

### Step S29:

The backup control unit 2 adds “1” to the first sector number. Additionally, the backup control unit 2 returns processing to step S22.

In this way, the backup control device 1 according to the present exemplary embodiment can control such that backup can be executed between different apparatuses even in environments not allowing backup therebetween. The reasons for that are as follows.

Specifically, the backup control device 1 generates the copy table 105 by the table generation processing based on the difference management table 103 for managing snapshots and the first generation number included in the backup request 101. Thereby, on the basis of the generated copy table 105, the backup control device 1 can easily determine, for each sector, the necessity or non-necessity of backup. In addition, when the backup control device 1 determines that backup is necessary, even if the primary apparatus is in operation, the backup control device 1 can use the snapshot function to control, for example, so as to allow backup in the secondary apparatus. Accordingly, even when specifications relating to an extension function such as backup are different between the primary and the secondary apparatuses or even when the secondary apparatus does not have such an extension function, the backup control device 1 can control so as to allow backup in the secondary apparatus. In other words, the backup control device 1 can achieve a backup-related control merely using the primary apparatus including the backup control device 1.

### Second Exemplary Embodiment

Next, a description will be given of a second exemplary embodiment based on the above-described backup control device 1 according to the first exemplary embodiment of the invention. The following description will focus mainly on characteristic parts of the present exemplary embodiment. In the description below, the same structures as those described in the above-described first exemplary embodiment are given the same reference numerals, and a duplicated description will be omitted.

A backup control device 21 according to the second exemplary embodiment of the invention will be described with reference to FIGS. 4, 7, and FIGS. 8A and 8B.

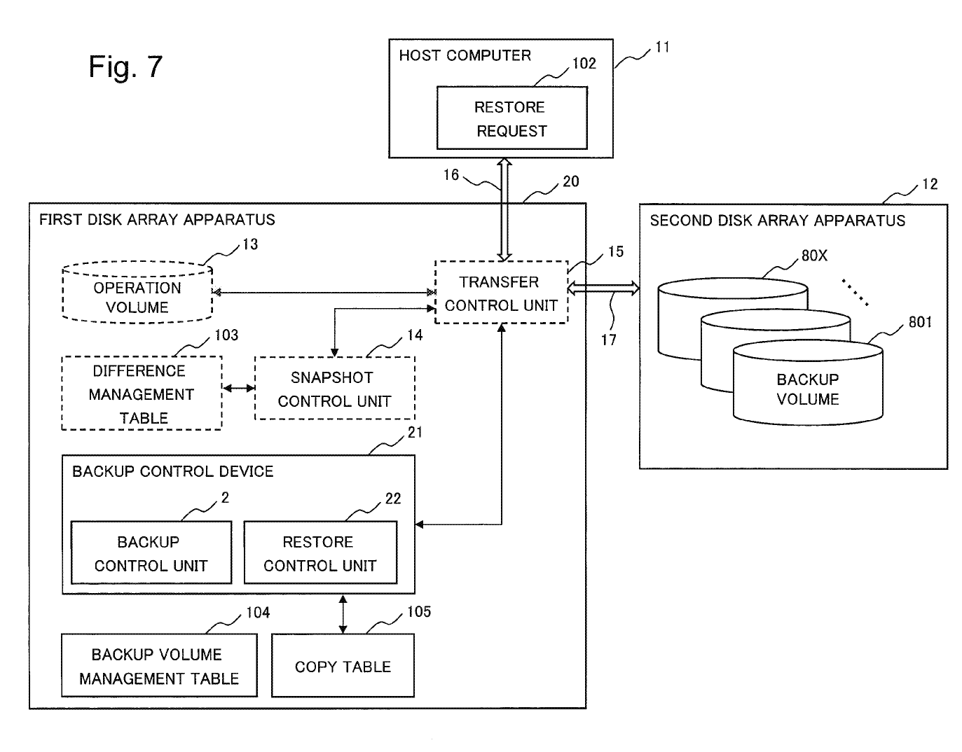

FIG. 7 is a block diagram depicting a structure of a first disk array apparatus 20 including the backup control device 21 according to the second exemplary embodiment of the invention.

In FIG. 7, the backup control device 21 includes a backup control unit 2 and a restore control unit 22.

In the present exemplary embodiment, the backup control device 21 is different from the backup control device 1 described in the first exemplary embodiment, in terms of further including the restore control unit 22 capable of restoring information backed up by the backup control unit 2.

More specifically, the restore control unit 22 starts processing in response to reception of the restore request 102 from, for example, an external apparatus such as the host computer 11 via the transfer control unit 15.

The restore request 102 herein includes a specific backup number as a restore target. More specifically, the restore request 102 is a backup-restore-command including, for example, the specific backup number.

For descriptive convenience in the description below, as one example, the specific backup number included in the restore request 102 will be referred to as first backup number.

More specifically, the restore control unit 22 obtains a volume number of the backup volume (a first volume) used at a time of the initial backup from the volume management table 104. In addition, the restore control unit 22 obtains a volume number of a backup volume (a second volume) associated with the first backup number from the volume management table 104 on the basis of the first backup number included in the restore request 102. In other words, the restore control unit 22 obtains a backup volume number used at a time of the differential backup from the volume management table 104.

The restore control unit 22 determines whether a restore to be executed is a restore from the initial backup or not on the basis of the first backup number included in the restore request 102. When the restore control unit 22 determines that the restore to be executed is a restore from the initial backup, the restore control unit 22 executes the following processing for each of all the first sector numbers included in the copy table 105. Specifically, the restore control unit 22 stores, in first difference information corresponding to each of the first sector numbers, information indicating that the sector with the first sector number is a sector requiring a restore from the information backed up in the initial backup. In other words, the restore control unit 22 causes the information indicating that the sector with the first sector number is a sector requiring a restore from the information backed up in the initial backup to be included in the first difference information corresponding to each first sector number. Then, the restore control unit 22 reads the copy table 105. On the other hand, when the restore control unit 22 determines that the restore to be executed is not a restore from the initial backup, the restore control unit 22 reads the copy table 105 from the backup volume (the second volume). When the restore control unit 22 determines that the restore to be executed is not a restore from the initial backup, the restore control unit 22 reads the copy table 105 used when backing up into the backup volume.

Next, the restore control unit 22 obtains, for each the first sector number, first difference information corresponding to the first sector number from the copy table 105. Additionally, on the basis of the obtained first difference information, the restore control unit 22 determines whether the sector with the first sector number is a sector requiring a restore from information backed up in the initial backup or a sector requiring a restore from information backed up in a differential backup. In other words, on the basis of the obtained first difference information, the restore control unit 22 determines whether the sector with the first sector number is a sector requiring a restore from the information backed up in the initial backup or a differential backup.

The restore control unit 22 executes the following processing when the restore control unit 22 determines that the sector is a sector requiring a restore from the information backed up in the differential backup as a result of the determination. Specifically, the restore control unit 22 requests information stored in the sector with the second sector number in the backup volume used at the differential backup from the second disk array apparatus 12 via the transfer control unit 15.

On the other hand, when the restore control unit 22 determines that the sector to be executed is a sector requiring a restore from the information backed up in the initial backup as a result of the determination, the restore control unit 22 executes the following processing. Specifically, the restore control unit 22 requests information stored in the sector with the second sector number in the backup volume used at the initial backup from the second disk array apparatus 12 via the transfer control unit 15.

The restore control unit 22 requests the operation volume 13 via the transfer control unit 15 to store the information obtained in response to the request in the sector with the first sector number corresponding to the second sector number.

Next, a more detailed description will be given below of an operation executed by the restore control unit 22 in the present exemplary embodiment.

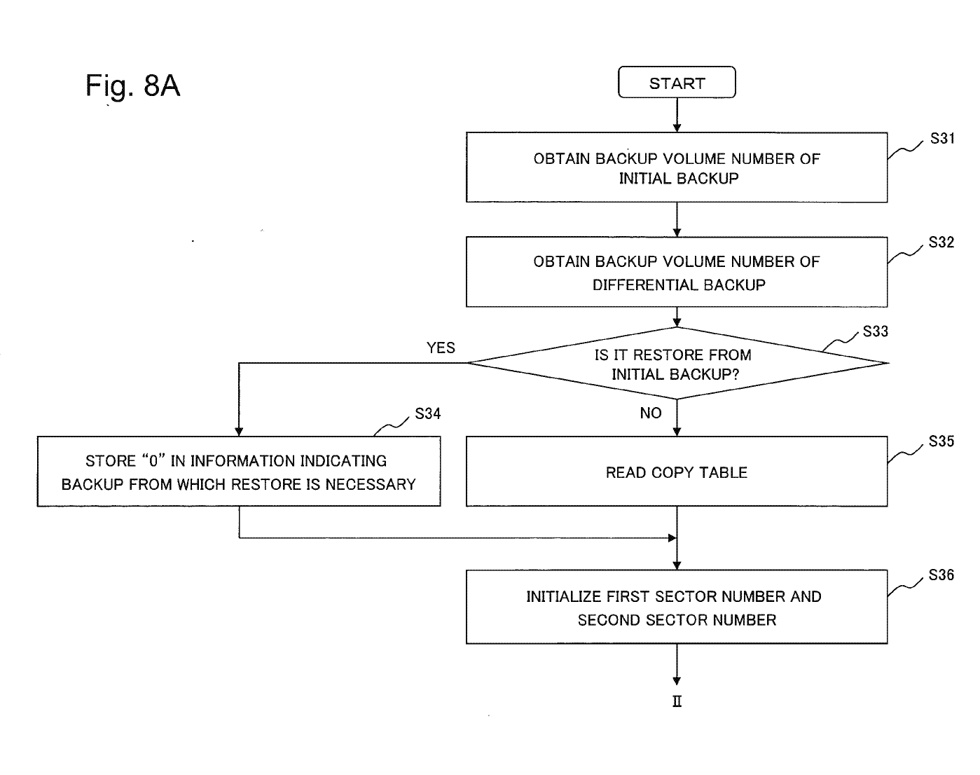

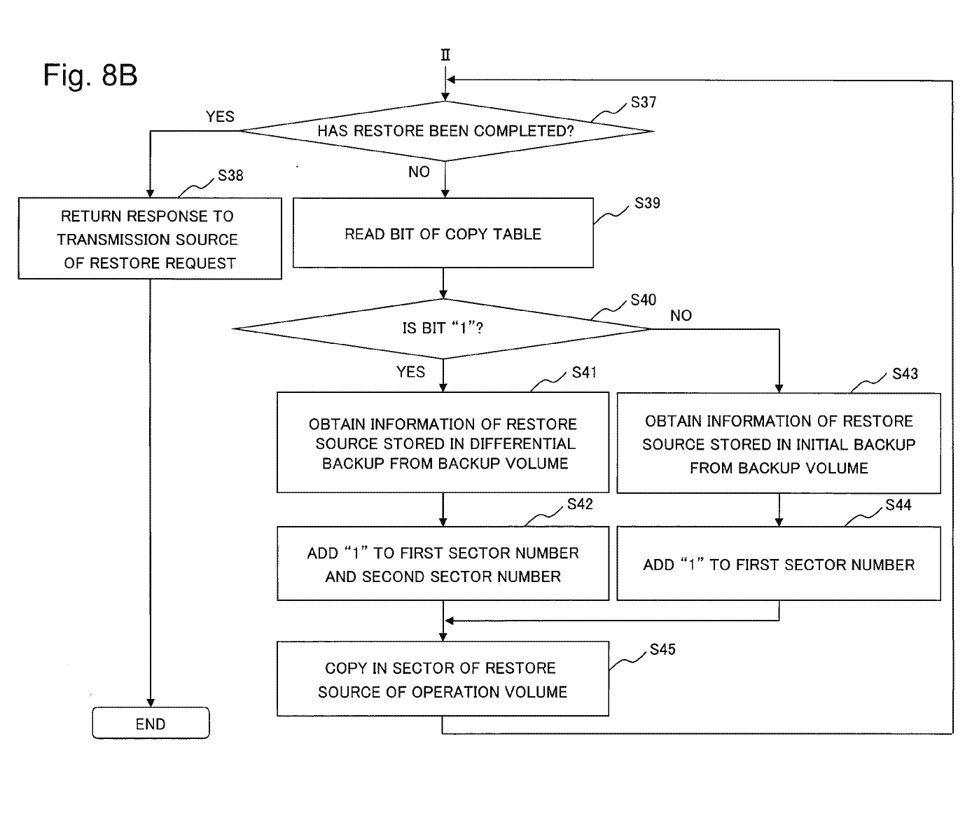

FIGS. 8A and 8B are a flowchart depicting an operation executed by the restore control unit 22 when receiving the restore request 102 in the second exemplary embodiment of the invention. Steps of the operation by the restore control unit 22 will be described in accordance with the flowchart.

### Step S31:

The restore control unit 22 refers to the volume management table 104. The restore control unit 22 obtains a volume number of the backup volume used at the initial backup from the volume management table 104.

More specifically, the restore control unit 22 refers to the volume management table 104. Then, the restore control unit 22 reads an entry of a backup number “1” indicating the initial backup from the volume management table 104. Additionally, the restore control unit 22 obtains a backup volume number corresponding to the read backup number “1”.

Herein, for descriptive convenience, as one example, the restore control unit 22 is assumed to acquire a backup volume number “801” corresponding to the backup number “1” from the volume management table 104 depicted in FIG. 4.

### Step S32:

The restore control unit 22 refers to the volume management table 104 on the basis of the first backup number included in the restore request 102. The restore control unit 22 obtains a volume number of the backup volume used at the differential backup from the volume management table 104.

More specifically, on the basis of the first backup number, the restore control unit 22 obtains a backup volume number corresponding to the first backup number from the referred volume management table 104.

### Step S33:

The restore control unit 22 determines whether the restore is a restore from the initial backup or not on the basis of the restore request 102.

More specifically, the restore control unit 22 determines whether or not the restore is a restore from the initial backup by determining whether or not the first backup number included in the restore request 102 is the backup number “1” indicating the initial backup.

### “YES” at Step S33:

The restore control unit 22 advances processing to step S34 when the restore control unit 22 determines that the restore is a restore from the initial backup as a result of determining whether or not it is a restore from the initial backup.

### “NO” at Step S33:

The restore control unit 22 advances processing to step S35 when the restore control unit 22 determines that the restore is not a restore from the initial backup as a result of determining whether or not it is a restore from the initial backup. In other words, the restore control unit 22 advances processing to step S35 when the restore control unit 22 determines that the restore is a restore from differential backup.

### Step S34:

The restore control unit 22 executes the following processing for each of all the first sector numbers included in the copy table 105. Specifically, the restore control unit 22 stores information indicating that the sector with the first sector number is a sector requiring a restore from the information backed up in the initial backup in the first difference information corresponding to each the first sector number. Furthermore, the restore control unit 22 associates each the first sector number with first difference information corresponding to the first sector number to store in the copy table 105. In other words, the restore control unit 22 associates each the first sector number with first difference information to cause them to be included in the copy table 105. In addition, the restore control unit 22 advances processing to step S36.

More specifically, as one example, the restore control unit 22 executes the following processing for each of all the first sector numbers. The restore control unit 22 store “0” on a bit that indicates first difference information corresponding to the first sector number. In this case, “0” is information indicating the sector requiring a restore from the information backed up in the initial backup. Furthermore, the restore control unit 22 associates the first sector number with the bit indicating the first difference information corresponding to the first sector number to store in the copy table 105.

### Step S35:

The restore control unit 22 requests the copy table 105 from the backup volume having the backup volume number obtained at step S32. The restore control unit 22 reads the copy table 105 obtained in response to the request.

More specifically, the restore control unit 22 transmits the read command to the second disk array apparatus 12 via the transfer control unit 15. The restore control unit 22 reads the copy table 105 obtained in response to the request from the second disk array apparatus 12 via the transfer control unit 15. The read command herein includes the backup volume number obtained at step S32 and a predetermined sector number of the backup volume.

Thereby, the second disk array apparatus 12 receives the read command from the restore control unit 22 via the transfer control unit 15. In addition, on the basis of the received command, the second disk array apparatus 12 reads a byte data sequence indicating the copy table 105 stored in a sector with the predetermined sector number in the backup volume having the backup volume number. Then, the second disk array apparatus 12 transmits the read byte data sequence to the restore control unit 22 via the transfer control unit 15.

### Step S36:

The restore control unit 22 initializes the first sector number as a restore destination and a second sector number as a restore source corresponding to the first sector number.

More specifically, the restore control unit 22 stores “0x00000001” as the initial value in the first sector number and stores “0x00000002” in the second sector number.

### Step S37:

The restore control unit 22 determines whether or not the restore into the operation volume 13 has been completed.

More specifically, as one example, the restore control unit 22 obtains a total number of sectors in the operation volume 13. The restore control unit 22 determines whether or not first sector number has exceeded the obtained total number of sectors.

### “YES” at Step S37:

The restore control unit 22 advances processing to step S38 when the restore control unit 22 determines that the restore into the operation volume 13 has been completed as a result of determining whether or not the restore thereinto has been completed.

### “NO” at Step S37:

The restore control unit 22 advances processing to step S39 when the restore control unit 22 determines that the restore into the operation volume 13 has not been completed as the result of determining whether or not the restore thereinto has been completed.

### Step S38:

The restore control unit 22 transmits a result of the execution to the transmission source of the restore request 102. In other words, the restore control unit 22 returns a response to the host computer 11 as the transmission source of the restore request 102.

### Step S39:

The restore control unit 22 refers to the copy table 105 read at step S35 on the basis of the first sector number. The restore control unit 22 obtains first difference information corresponding to the first sector number from the copy table 105.

More specifically, the restore control unit 22 reads a bit indicating the first difference information corresponding to the first sector number from the copy table 105.

### Step S40:

The restore control unit 22 determines whether the sector with the first sector number is a sector requiring a restore from the information backed up in the initial backup or a sector requiring a restore from the information backed up in the differential backup on the basis of the obtained first difference information.

### “YES” at Step S40:

The restore control unit 22 advances processing to step S41 when the restore control unit 22 determines that the sector is a sector requiring a restore from the information backed up in the differential backup as a result of the determination.

More specifically, when the bit indicating the first difference information is “1”, the restore control unit 22 determines that the sector with the first sector number is a sector requiring a restore from the information backed up in the differential backup.

### “NO” at Step S40:

The restore control unit 22 advances processing to step S43 when the restore control unit 22 determines that the sector is a sector requiring a restore from the information backed up in the initial backup as the result of the determination.

More specifically, when the bit indicating the first difference information is “0”, the restore control unit 22 determines that the sector with the first sector number is a sector requiring a restore from the information backed up in the initial backup.

### Step S41:

The restore control unit 22 requests the information stored in the sector with the second sector number in the backup volume used at the differential backup from the second disk array apparatus 12 via the transfer control unit 15.

More specifically, the restore control unit 22 transmits a read command to the second disk array apparatus 12 via the transfer control unit 15. The read command herein includes the backup volume number obtained at step S32 and the second sector number.

Thereby, the second disk array apparatus 12 receives the read command from the restore control unit 22 via the transfer control unit 15. Additionally, on the basis of the received command, the second disk array apparatus 12 reads a byte data sequence stored in the sector with the second sector number in the backup volume having the backup volume number. The second disk array apparatus 12 transmits the read byte data sequence to the restore control unit 22 via the transfer control unit 15.

### Step S42:

The restore control unit 22 adds “1” to the first sector number and the second sector number corresponding to the first sector number.

### Step S43:

The restore control unit 22 requests information stored in the sector with the first sector number in the backup volume used at the initial backup from the second disk array apparatus 12 via the transfer control unit 15.

More specifically, the restore control unit 22 transmits the read command to the second disk array apparatus 12 via the transfer control unit 15. The read command herein includes the backup volume number obtained at step S31 and the first sector number.

Thereby, the second disk array apparatus 12 receives the read command from the restore control unit 22 via the transfer control unit 15. In addition, on the basis of the received command, the second disk array apparatus 12 reads a byte data sequence stored in the sector with the first sector number in the backup volume having the backup volume number. The second disk array apparatus 12 transmits the read byte data sequence to the restore control unit 22 via the transfer control unit 15.

### Step S44:

The restore control unit 22 adds “1” to the first sector number. Additionally, the restore control unit 22 advances processing to step S45.

Specifically, when the restore control unit 22 requests the information of the restore source stored in the differential backup, the restore control unit 22 adds “1” to the first sector number and the second sector number. On the other hand, when the restore control unit 22 requests the information of the restore source stored in the initial backup, the restore control unit 22 adds “1” to the first sector number.

### Step S45:

The restore control unit 22 requests the operation volume 13 via the transfer control unit 15 to store the information obtained in response to the request in the sector with the first sector number. Additionally, the restore control unit 22 returns processing to step S37.

More specifically, the restore control unit 22 transmits the write command to the operation volume 13 via the transfer control unit 15. The write command herein includes a byte data sequence obtained in response to the request, a volume number capable of identifying the operation volume 13, and the first sector number.

Thereby, the operation volume 13 receives the write command from the restore control unit 22 via the transfer control unit 15. In addition, on the basis of the received command, the operation volume 13 stores the byte data sequence in the sector with the first sector number of the operation volume 13.

In this way, the restore control unit 22 allows a restore from the information backed up in either the differential backup or the initial backup into the operation volume 13. In other words, when it is necessary to execute a restore from information backed up in the differential backup, the restore control unit 22 can restore information stored in the backup volume of the second disk array apparatus 12 built at the differential backup into the operation volume 13. More specifically, the restore control unit 22 can restore the information stored in the sector with the second sector number in the backup volume into the sector with the first sector number of the operation volume 13.

In addition, when it is necessary to restore from the information backed up in the initial backup, the restore control unit 22 can restore information stored in the backup volume of the second disk array apparatus 12 built at the initial backup into the operation volume 13. More specifically, the restore control unit 22 can restore the information stored in the sector with the first sector number in the backup volume into the sector with the first sector number of the operation volume 13.

The present exemplary embodiment described above has described, for descriptive convenience, one example of the structure of the backup control device 21 in which the backup control unit 2 and the restore control unit 22 are achieved by the same (in other words, integrated) device. However, the backup control device 21 according to exemplary embodiments of the present invention is not limited thereto. For example, the backup control device 21 may adopt a structure in which the backup control unit 2 and the restore control unit 22 are achieved by discrete devices. Alternatively, the backup control device 21 may adopt a structure, for example, in which the backup control unit 2 and the restore control unit 22 are virtually achieved by a single information processor.

In this manner, the backup control device 21 according to the present exemplary embodiment can provide the advantageous effect described in the first exemplary embodiment, as well as can control such that restore can be executed between different apparatuses even in environments not allowing restore therebetween. The reasons for that are as follows.

Specifically, on the basis of the copy table 105, the backup control device 21 can determine whether the sector with the first sector number is a sector requiring a restore from the information backed up in the initial backup or the differential backup. The backup control device 21 executes the following processing when the backup control device 21 determines that the sector is a sector requiring a restore from the information backed up in the differential backup. Specifically, on the basis of a volume number of the backup volume used at the differential backup and the second sector number, the backup control device 21 requests the information stored in the sector with the second sector number from the second disk array apparatus 12. On the other hand, the backup control device 21 executes the following processing when the backup control device 21 determines that the sector is a sector requiring a restore from the information backed up in the initial backup. Specifically, on the basis of the volume number of the backup volume used at the initial backup and the first sector number, the backup control device 21 requests the information stored in the sector with the first sector number from the second disk array apparatus 12. Additionally, the backup control device 21 can control such that the information obtained in response to the request is restored in the sector with the first sector number of the operation volume 13 as the restore destination. This allows the operation volume 13 to copy the information in the sector designated by the first sector number. In addition, the backup control device 21 can control such that restore can be executed in a secondary apparatus even when a primary apparatus and the secondary apparatus are different in terms of specifications relating to extension functions for restore and the like or even when the secondary apparatus does not have such extension functions. In other words, the backup control device 21 can achieve controls relating to backup and restore merely by the primary apparatus including the backup control device 21.

### Third Exemplary Embodiment

Next, a description will be given of a third exemplary embodiment based on the backup control device 21 according to the second exemplary embodiment of the invention described above. The following description will focus mainly on characteristic parts of the present exemplary embodiment. In the description below, the same structures as those in the respective exemplary embodiments described above are given the same reference numerals, and a duplicated description will be omitted.

A backup control device 31 according to the third exemplary embodiment of the invention will be described with reference to FIG. 5, FIGS. 6A and 6B, FIGS. 8A and 8B, and FIG. 9.

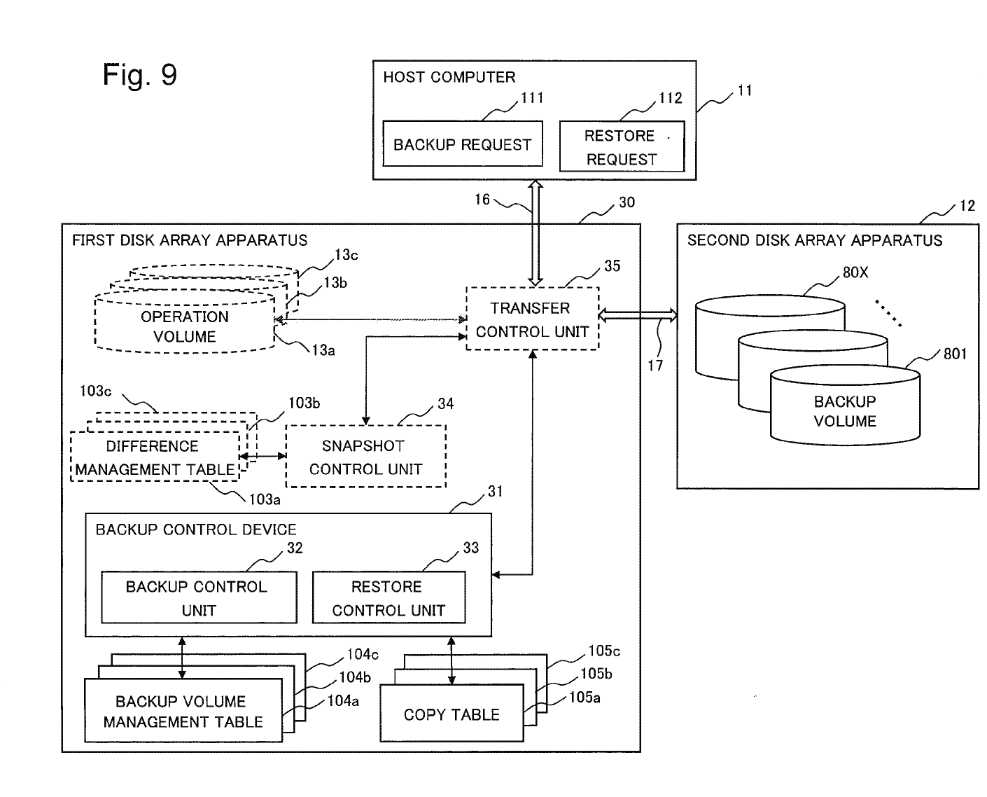

FIG. 9 is a block diagram depicting a structure of a first disk array apparatus 30 including the backup control device 31 according to the third exemplary embodiment of the invention.

In FIG. 9, the backup control device 31 includes a backup control unit 32 and a restore control unit 33.

The first disk array device 30 includes operation volumes 13a to 13c, a snapshot control unit 34, a transfer control unit 35, difference management tables 103a to 103c, volume management tables 104a to 104c, and copy tables 105a to 105c.

Specifically, the first disk array apparatus 30 includes, for each of the operation volumes (13a to 13c), each of the difference management tables (103a to 103c), each of the volume management tables (104a to 104c), and each of the copy tables (105a to 105c) corresponding to each of the operation volumes (13a to 13c).

The present exemplary embodiment described above has described, for descriptive convenience, one structural example of the first disk array apparatus 30 including the three operation volumes (13a to 13c). However, the first disk array apparatus 30 according to exemplary embodiments of the invention is not limited thereto. The first disk array apparatus 30 may adopt a structure having a plurality of operation volumes (1, 2, 3, . . . n, and n+1).

In addition, for descriptive convenience in the description below, “operation volumes 13a to 13c” will be referred to collectively as “operation volume”, “difference management tables 103a to 103c” will be referred to collectively as “difference management table”, “volume management tables 104a to 104c” will be referred to collectively as “volume management table”, and “copy tables 105a to 105c” will be referred to collectively as “copy table”.

In response to reception of a backup request 111, the backup control unit 32 executes the backup processing described in FIG. 5 and FIGS. 6A and 6B into an operation volume designated by the backup request 111.

The backup request 111 herein includes a generation number indicating a snapshot generation and a volume number capable of identifying the operation volume.

In addition, in response to reception of a restore request 112, the restore control unit 33 executes the restore processing described in FIGS. 8A and 8B into an operation volume designated by the restore request 112.

The restore request 112 herein includes a specific backup number as a restore target and a volume number of the operation volume.

In this way, the backup control device 31 executes the processing described in each exemplary embodiment for each operation volume, and thus a duplicated description will be omitted.

Next, the snapshot control unit 34 not only manages, for each generation, a snapshot of an operation volume as a backup target but also manages a snapshot for each operation volume. Accordingly, there is a difference management table for each operation volume.

When receiving a snapshot-acquisition-command further including a volume number of an operation volume, the snapshot control unit 34 acquires a snapshot of the designated operation volume at the time of the reception of the command.

On the other hand, when receiving a snapshot-read-command further including a volume number of an operation volume, the snapshot control unit 34 executes the following processing. Specifically, the snapshot control unit 34 reads a byte data sequence stored in a sector designated by a first sector number in a snapshot generation acquired for the operation volume designated by the command. Then, the snapshot control unit 34 transmits the read byte data sequence to a transmission source of the command. The snapshot-read-command herein includes a generation number indicating the snapshot generation, the first sector number, and the volume number of the operation volume.

In this way, the backup control device 31, the snapshot control unit 34, and the transfer control unit 35 execute processing described in each of the exemplary embodiments for each of the operation volumes (13a to 13c) designated by each kind of command, and thus a duplicated description will be omitted.

Thus, the backup control device 31 according to the present exemplary embodiment can provide the advantageous effect described in each exemplary embodiment, as well as can control such that backup or restore can be executed in a plurality of operation volumes even in environments not allowing backup or restore between difference apparatuses.

The reason for that is that the backup control device 31 can execute the processing described in each embodiment for each operation volume. In addition, the backup control device 31 is suitably applied to a disk array apparatus.

### (Example of Hardware Structure)

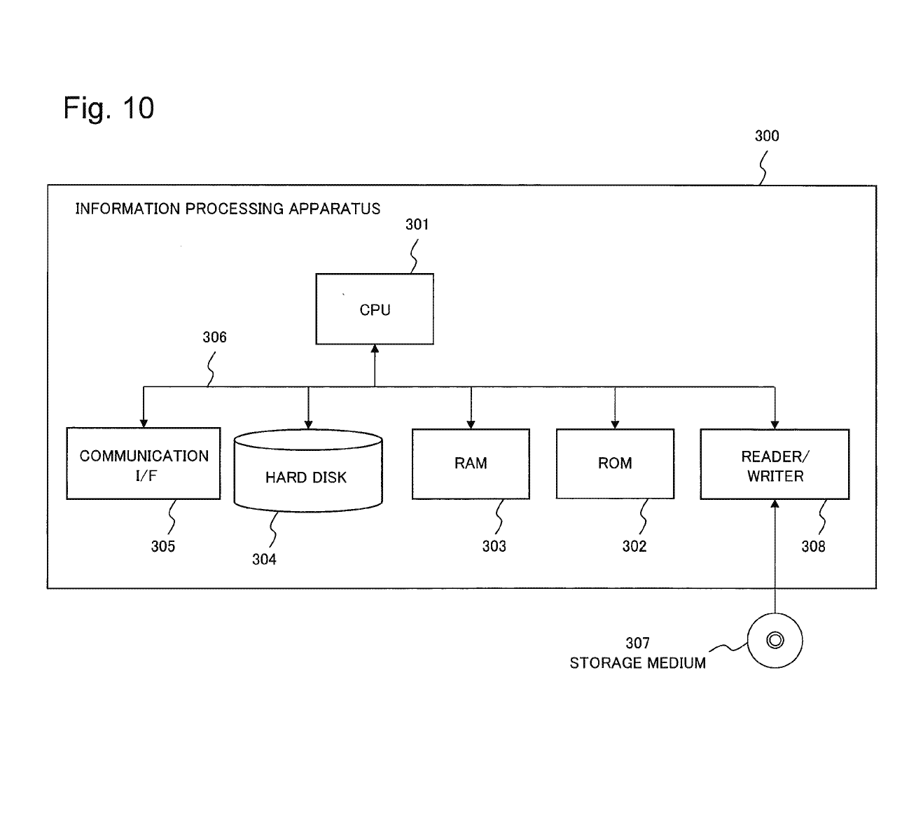

The respective units depicted in the drawings in the exemplary embodiments described above can be regarded as functional units of a software program (processing units or software modules). The respective software modules may be achieved by exclusive hardware. However, sorting of the respective units depicted in the drawings represents a structure depicted for descriptive convenience, and various structures can be assumed when mounting the units. One example of hardware environment in this case will be described below with reference to FIG. 10.

FIG. 10 is a diagram exemplarily illustrating a structure of an information processing apparatus 300 (computer) that allows for execution by the backup control device according to any of the exemplary embodiments of the invention. Specifically, FIG. 10 depicts a structure of a computer (information processor) such as a server, and represents a hardware environment capable of achieving each function in the above-described embodiments. The computer can achieve all or some of the backup control device 1 (FIG. 1), the backup control device 21 (FIG. 7), and the backup control device 31 (FIG. 9).

The information processing apparatus 300 depicted in FIG. 10 is an ordinary computer in which the following components are connected to each other via a bus 306 (a communication channel).

CPU (CENTRAL_PROCESSING_UNIT) 301;

ROM (READ_ONLY_MEMORY) 302;

RAM (RANDOM_ACCESS_MEMORY) 303;

Hard disk 304 (Storage apparatus);

Communication interface 305 (INTERFACE: hereinafter referred to as “I/F”) for communicating with an external apparatus; and

Reader/writer 308 that can read/write data stored in a storage medium 307, such as a CD-ROM (COMPACT_DISC_READ_ONLY_MEMORY).

Then, the present invention described by exemplifying the exemplary embodiments described above can be accomplished by the following steps. Specifically, in the information processing apparatus 300 depicted in FIG. 10, there is provided a computer program that can achieve the functions of the block structure diagrams (FIGS. 1, 7, and 9) or the flowcharts (FIG. 5, FIGS. 6A and 6B, and FIGS. 8A and 8B) referred to in the description thereof. Then, the computer program is read and executed by the CPU 301 of the hardware to be achieved. In addition, the computer program provided in the information processor may be stored in a nonvolatile storage apparatus such as a readable/writable temporary storage memory (the RAM 303) or the hard disk 304.

In the above case, as a method for providing the computer program in the hardware, currently common steps can be adopted. Example of the providing method include installation of the computer program in the hardware via the storage medium 307 of any kind, such as a CD-ROM and downloading of the computer program from outside via a communication channel such as the Internet. In such a case, the present invention can be regarded as including codes composing the computer program or a storage medium storing the codes.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

### DESCRIPTION OF REFERENCE NUMERALS

1 Backup control device
2 Backup control unit
3 Restore control unit
10 First disk array apparatus
11 Host computer
12 Second disk array apparatus
13, 13a, 13b, 13c Operation volume
14 Snapshot control unit
15 Transfer control unit
16 Interface
17 Interface
20 First disk array apparatus
21 Backup control device
22 Restore control unit
30 First disk array apparatus
31 Backup control device
32 Backup control unit
33 Restore control unit
34 Snapshot control unit
35 Transfer control unit
101, 111 Backup request
102, 112 Restore request
103, 103a, 103b, 103c Difference management table
104, 104a, 104b, 104c Backup volume management table
105 Copy table
801, 80X Backup volume
300 Information processing apparatus
301 CPU
302 ROM
303 RAM
304 Hard disk
305 Communication interface
306 Bus
307 Storage medium
308 Reader/writer

1. A backup control device comprising:
a backup control unit that, in response to a backup request including a generation number of a snapshot, determines whether a backup to be executed is an initial backup or a differential backup on the basis of volume management information including a backup number capable of identifying the backup and a volume number capable identifying one or more volumes built in a storage apparatus as a backup destination, generates different copy information depending on a result of the determination on the basis of the generation number and difference management information managing the snapshot,
determines a necessity or non-necessity of the backup for each of one or more first sector numbers composing an operation volume on the basis of the generated copy information,
when the backup is determined to be necessary, requests, on the basis of a first sector number requiring the backup and the generation number, information stored in a sector with the first sector number from a snapshot control unit and
requests the storage apparatus to store the information acquired in response to the request in a sector with a second sector number in the volume corresponding to the first sector number.

2. The backup control device according to claim 1, further comprising a restore control unit that, in response to a restore request including a specific backup number as a restore target, obtains the volume number of a first volume used at a time of the initial backup and the volume number of a second volume used at a time of the differential backup on the basis of the volume management information and the specific backup number,
determines whether a restore to be executed is a restore from the initial backup or not on the basis of the specific backup number, when the restore is determined to be a restore from the initial backup, causes information indicating that the sector with the first sector number is a sector requiring a restore from the initial backup to be included in the copy information and reads the copy information, and when the restore is determined not to be a restore from the initial backup, reads the copy information used at the time of the backup in the second volume,
determines, in the each first sector number, whether the sector with the first sector number is a sector requiring a restore from information backed up in the initial backup or the differential backup on the basis of the read copy information,
when the sector is determined to be a sector requiring a restore from the initial backup, requests the information stored in the sector with the first sector number from the storage apparatus on the basis of the obtained volume number of the first volume and the first sector number, and
when the sector is determined to be a sector requiring a restore from the differential backup, requests the information stored in the sector with the second sector number from the storage apparatus on the basis of the obtained volume number of the second volume and the second sector number, and
requests the operation volume to restore the information acquired in response to the request in the sector with the first sector number in the operation volume.

3. The backup control device according to claim 1, wherein
the copy information includes, in the each first sector number, the first sector number and first difference information indicating a presence or absence of a difference having occurred after the initial backup; and
when the backup is determined to be the initial backup, the backup control unit generates the copy information such that all of the sectors with the one or more first sector numbers become a backup target, and
when the backup is determined to be the differential backup, the backup control unit generates the copy information such that, of the sectors with the one or more first sector numbers, one or more sectors in which a difference has occurred after the initial backup become a backup target.

4. The backup control device according to claim 3, wherein
the difference management information includes, for each generation, the first sector number and second difference information indicating whether or not a difference has occurred in the operation volume after acquiring the snapshot; and
when the backup is determined to be the initial backup, the backup control unit generates the copy information by causing information indicating an occurrence of a difference to be included in the first difference information in the each first sector number, and
when the backup is determined to be the differential backup, the backup control unit generates the copy information by causing information indicating a non-occurrence of a difference to be included in the first difference information in the each first sector number, setting a generation immediately before a generation with the generation number as a logical sum calculation target, calculating a logical sum between the first difference information including the information and the second difference information in the generation set as the logical sum calculation target obtained from the difference management information, associating the logical sum with the first sector number to include in the copy information,
the calculation of the logical sum being executed for generations before generations with all generation numbers included in the difference management information.

5. The backup control device according to claim 1, wherein
the backup control unit calculates a capacity of a volume necessary for the backup to be executed on the basis of the copy information, and requests the storage apparatus to build a volume on the basis of the calculated capacity and the volume number.

6. A disk array apparatus comprising the backup control device according to claim 1.

7. A backup control method comprising, by an information processing apparatus:
in response to a backup request including a generation number of a snapshot, determining whether a backup to be executed is an initial backup or a differential backup on the basis of volume management information including a backup number capable of identifying of the backup and a volume number capable of identifying of one or more volumes built in a storage apparatus as a backup destination;
generating different copy information depending on a result of the determination on the basis of the generation number and difference management information managing the snapshot;
determining a necessity or non-necessity of the backup for each of one or more first sector numbers composing an operation volume on the basis of the generated copy information;
when the backup is determined to be necessary, requesting, on the basis of a first sector number requiring the backup and the generation number, information stored in a sector with the first sector number from a snapshot control unit; and
requesting the storage apparatus to store the information acquired in response to the request in a sector with a second sector number in the volume corresponding to the first sector number.

8. The backup control method according to claim 7, wherein the method comprises:
in response to a restore request including a specific backup number as a restore target, obtaining the volume number of a first volume used at a time of the initial backup and the volume number of a second volume used at a time of the differential backup on the basis of the volume management information and the specific backup number;
determining whether a restore to be executed is a restore from the initial backup or not on the basis of the specific backup number; when the restore is determined to be a restore from the initial backup, causing information indicating that the sector with the first sector number is a sector requiring a restore from the initial backup to be included in the copy information and reads the copy information; and when the restore is determined not to be a restore from the initial backup, reading the copy information used at the time of the backup in the second volume;
determining, in the each first sector number, whether the sector with the first sector number is a sector requiring a restore from information backed up in the initial backup or the differential backup on the basis of the read copy information;
when the sector is determined to be a sector requiring a restore from the initial backup, requesting the information stored in the sector with the first sector number from the storage apparatus on the basis of the obtained volume number of the first volume and the first sector number; and
when the sector is determined to be a sector requiring a restore from the differential backup, requesting the information stored in the sector with the second sector number from the storage apparatus on the basis of the obtained volume number of the second volume and the second sector number; and
requesting the operation volume to restore the information acquired in response to the request in the sector with the first sector number in the operation volume.

9. A non-transitory computer readable storage medium storing a computer program that causes a computer to execute:
a function that in response to a backup request including a generation number of a snapshot, determining whether a backup to be executed is an initial backup or a differential backup on the basis of volume management information including a backup number capable of identifying the backup and a volume number capable of identifying one or more volumes built in a storage apparatus as a backup destination,
generating different copy a information depending on a result of the determination on the basis of the generation number and a difference management information managing the snapshot,
determining a necessity or non-necessity of the backup for each of one or more first sector numbers composing an operation volume on the basis of the generated copy information,
when the backup is determined to be necessary, requesting, on the basis of a first sector number requiring the backup and the generation number, information stored in a sector with the first sector number from a snapshot control unit, and
requesting the storage apparatus to store the information acquired in response to the request in a sector with a second sector number in the volume corresponding to the first sector number.

10. The non-transitory computer readable storage medium according to claim 9, the computer program causing the computer to further execute:
a function that in response to a restore request including a specific backup number as a restore target, obtaining the volume number of a first volume used at a time of the initial backup and the volume number of a second volume used at a time of the differential backup on the basis of the volume management information and the specific backup number,
determining whether a restore to be executed is a restore from the initial backup or not on the basis of the specific backup number, when the restore is determined to be a restore from the initial backup, causing information indicating that the sector with the first sector number is a sector requiring a restore from the initial backup to be included in the copy information and reads the copy information, and when the restore is determined not to be a restore from the initial backup, reading the copy information used at the time of the backup in the second volume,
determining, in the each first sector number, whether the sector with the first sector number is a sector requiring a restore from information backed up in the initial backup or the differential backup on the basis of the read copy information,
when the sector is determined to be a sector requiring a restore from the initial backup, requesting the information stored in the sector with the first sector number from the storage apparatus on the basis of the obtained volume number of the first volume and the first sector number, and
when the sector is determined to be a sector requiring a restore from the differential backup, requesting the information stored in the sector with the second sector number from the storage apparatus on the basis of the obtained volume number of the second volume and the second sector number, and
requesting the operation volume to restore the information acquired in response to the request in the sector with the first sector number in the operation volume.
